(19) United States
(12) Patent Application Publication
(10) Pub. No.: US 2026/0003375 A1
(43) Pub. Date: Jan. 1, 2026

(54) SYSTEMS AND METHODS FOR A MASS FLOW CONTROLLER

(71) Applicant: INFINITI SOLUTIONS INC, Henderson, NV (US)

(72) Inventors: Arushi Somani, Yorba Linda, CA (US); Aayush Somani, Yorba Linda, CA (US); Vinay Kumar Devireddy, Fullerton, CA (US)

(73) Assignee: INFINITI SOLUTIONS INC, Henderson, NV (US)

(21) Appl. No.: 19/251,789

(22) Filed: Jun. 26, 2025

Related U.S. Application Data
(60) Provisional application No. 63/664,512, filed on Jun. 26, 2024.

(51) Int. Cl. G05D 7/06

(52) U.S. Cl. CPC G05D 7/0623; G05D 7/0635

(57) ABSTRACT

Systems, methods, and a device for mass flow control are disclosed. A method includes providing a main fluid flow path for a fluid. The main fluid flow path includes an inlet, a fluid centered downstream from the inlet, and a proportional valve downstream from the inlet. The method further includes receiving instructions wirelessly from my first wireless controller and adjusting the proportional valve, which is responsive to the instructions, to control the flow of fluid through the main fluid flow path.

### CROSS REFERENCE TO PRIOR APPLICATION

This application claims the benefit of U.S. Provisional Patent Application No. 66/134,551, entitled “SYSTEMS AND METHODS FOR A MASS FLOW CONTROLLER”, filed Jun. 26, 2024, which is incorporated by reference in its entirety.

### FIELD OF THE INVENTION

This disclosure relates to the field of mass flow controllers, specifically the transmission of data to and from mass flow controllers.

### BACKGROUND

Mass flow controllers are used to control the flow rate of a fluid. The fluid may be a gas or liquid. A mass flow controller may be configured to adjust a gas flow based on properties such as temperature, pressure, and volume. Mass flow controllers may be used in various industries, such as semiconductor fabrication, which requires a precise flow and composition of a gas. Mass flow controllers tend to be finely tuned and calibrated. They also tend to be hardwired into a manufacturing setting.

Changing any settings or parameters on the finely tuned and calibrated vessel controller may be a painstaking process that involves disconnecting the mass flow controller from a bigger process. There is a continual need in the art for improvements in mass flow controllers that make them more precise and easier to use.

### SUMMARY

The disclosed subject matter is systems, methods, and devices for mass flow control. The mass flow control system includes a main fluid flow path with various sensors to measure the properties of a fluid flowing through the main fluid flow path. Also attached to the main fluid flow path are one or more valves for controlling a massive fluid that flows through the main fluid flow path. One or more controllers wirelessly communicate with at least one of the sensors and/or valves attached to the main fluid flow path. The one or more controllers and wireless communication may receive measurements from the sensors and transmit instructions to the valves to adjust a flow of fluid through the main fluid flow path. One or more wireless controllers may receive one or more requests to modify the settings of the mass flow control system. The one or more wireless controllers may evaluate the request based on one or more conditions.

### BRIEF DESCRIPTION OF THE DRAWINGS

FIG. 1 is a schematic diagram of an embodiment of the disclosed system for mass flow control.

FIG. 2 is a flow diagram of a process for modifying one or more parameters in an embodiment of the disclosed system for mass flow control.

FIG. 3 is a schematic diagram of a communication system between multiple mass flow controllers, a first wireless controller, and a second wireless controller, in an embodiment of the disclosed system for mass flow control.

FIG. 4 is a flow diagram for an embodiment of the disclosed process for controlling fluid flow with an embodiment of the disclosed system for mass flow control.

FIG. 5 is a schematic of an embodiment of a computing system that may perform one or more computing functions and embodiments of the disclosed system for mass flow control.

### DETAILED DESCRIPTION

The disclosed subject matter is systems, methods, and devices for mass flow controllers that are easier to modify and reconfigure in the field. The disclosed mass flow controller may include bringing controllers wirelessly connected to valves, sensors, and fluid flow past in a flow control system. A user may efficiently modify one or more settings of the disclosed mass flow controller via wireless communication. Further, the user may receive one or more statuses from a mass flow controller via wireless communication.

A first controller may be in wireless communication with more mass flow control systems. A second controller may wirelessly request the first controller to change one or more parameters of at least one of the mass flow controllers. The first controller may grant the request if the request satisfies one or more conditions. Accordingly, the first controller may modify one or more parameters on at least one of the mass flow control systems responsive to a request made by a second controller.

In an example embodiment, a request sent wirelessly from the second controller may be received by a wired controller connected to at least one of the mass flow control systems. The wired controller may evaluate one or more parts of the request to modify a parameter or change a setting for the mass control system. Alternatively, the wired controller may relay the request or a part of the request wirelessly to the first controller. Accordingly, the first controller may evaluate a request relayed from a second controller that communicated wirelessly with a wired controller.

More than one mass flow controller may be connected to a system for managing mass flow control. For example, multiple controllers, each controlling a flow of a separate gas, may be connected so that each separate gas is combined according to a preset ratio. A request to modify a flow rate or a parameter for one of the mass controllers may change the ratio unless parameters or settings for the other mass flow controllers in the system are also changed. The request may be evaluated to ensure that the ratio remains within a preset range. In various embodiments, the request may be received by a controller connected via a wired connection to one of the mass flow controllers in the system. A wired controller may then relay the request to a managing controller that manages all controllers in the system.

The fluid flow rate moving through one or more mass flow controllers may be determined at least in part by the sensors. Where the fluid is a gas, measurements of pressure, temperature, and volume may be used to determine the mass of gas passing through a mass flow controller using the ideal gas law. Accordingly, sensors may be configured to measure temperature and/or pressure. Volume may be determined by passing the fluid through a known volume. In various embodiments, the mass of the gas may be determined by the real gas law, where a compressibility factor is determined based on the composition of the gas.

In various embodiments, one or more mass flow controllers may evaluate a gas composition and wirelessly relay the composition evaluation to a central managing controller that may determine one or more parameter modifications to flow rates for one or more gases in the mass flow control system. In various embodiments, one or more of the gases may be combined. The compressibility factor or other factors may be determined based on the composition of the combined gases. Change in composition, as evaluated by one or more sensors in the one or more mass flow controllers may be relayed to a managing controller to determine a compressibility.

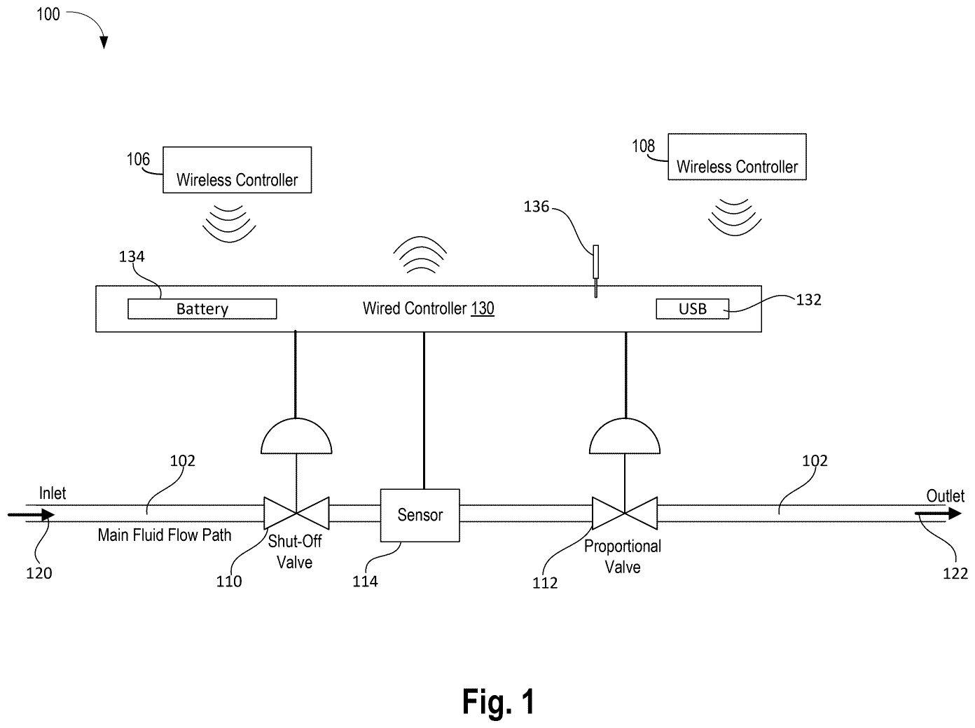

Referring to FIG. 1, FIG. 1 is a schematic diagram of an embodiment of the disclosed system 100 for mass flow control. The system 100 may control fluid flow through a main fluid flow path 102. The fluid may enter the system 100 through an inlet 120 and exit the system 100 through an outlet 122. The system 100 may control the amount of fluid that flows through it by adjusting an opening in a proportional valve 112. An example of a proportional valve 112 is a solenoid valve.

In an example embodiment, the system 100 may include a shut-off valve 110 that is configured to control access to the system 100 through the inlet 120. The shut-off valve 110 is positioned at the inlet 120 in various embodiments. The system 100 may include one or more sensors 114 that are configured to take measurements of the fluid flowing through the main fluid flow path 102.

Examples of the one or more sensors 114 include, but are not limited to, temperature sensors, and pressure sensors. In an example embodiment, temperature may be measured by measuring resistance in a solenoid valve. The shut-off valve 110 and proportional valve 112 may comprise A solenoid valve configured to measure the temperature of the fluid by measuring the resistance and the solenoid valve.

The system 100 may include a proportional valve 112 and one or more additional valves, such as the shut-off valve 110. The proportional valve 112 may be configured to proportionately open to control fluid flow through the proportional valve 112. Fluid that exits the system 100 through the outlet 122 will flow at a rate controlled based on the opening of the proportional valve 112.

The opening of the proportional valve 112 and additional valves, such as the shut-off valve 110, may be controlled by a wired controller 130 by sending electrical signals to the proportional valve 112 or other valves. The wired controller 130 may also receive measurements from the one or more sensors 114 such as pressure and temperature measurements. In an example embodiment, the wired controller 130 may receive one or more measurements from the one or more sensors 114 that indicate a flow rate of the fluid flowing through the main fluid flow path 102.

The wired controller 130 may determine an adjustment to an opening of the proportional valve 112 to control the flow rate of the fluid based on the measurement from the one or more sensors 114. For instance, the wired controller 130 may have a set point flow rate parameter. The wired controller 130 may adjust the proportional valve 112 to cause the fluid moving through the main fluid flow path 102 to flow at a rate equal to the set point flow rate.

In various embodiments, the one or more valves and one or more sensors 114 may send and receive digital signals wirelessly from a first wireless controller 106. The first wireless controller 106 may manage the wired controller 130 by sending instructions related to the various parts of the system 100. For example, the proportional valve 112 may receive an instruction from the wired controller 130 relayed from the first wireless controller 106. The one or more sensors 114 may transmit measurements through the wired controller 130 to the first wireless controller 106.

The first wireless controller 106 may communicate with other parts of the system 100 via various wireless protocols such as Wi-Fi and Bluetooth. The wired controller 130 may communicate with one or more wireless controllers. For example, the wired controller 130 may be in wireless communication with a first wireless controller 106 and a second wireless controller 108. In an example embodiment, the second wireless controller 108 may transmit a request to the wired controller 130 to change one or more parameters in the system 100. A change in parameter may include a change in fluid flow rate, tuning, calibration, or other parameters used in determining an adjustment and the proportional valve, such as the composition of the fluid.

The wired controller 130 may relay the request to the first wireless controller 106 to evaluate the request based on one or more conditions. An example of the one or more conditions may be a condition that the set point flow rate stays within a set range. Another example of a condition may be a list of compositions or composition ranges for the fluid. For example, the first wireless controller 106 may include a condition that the composition of the fluid should be no less than 80% nitrogen gas. As mentioned above, the composition of the fluid may influence the determination of the flow rate based on measurements from the sensor.

The antenna 136 is detachable and facilitates communication between the wired controller 130, the first wireless controller 106, and the second wireless controller 108. An antenna transmits and receives electromagnetic waves to enable wireless communication. Various examples of antennas that may be the antenna 136 include monopole antennas, dipole antennas, and patch antennas.

The antenna 136 may be positioned on the wired controller 130 to transmit and receive data. In cases of interrupted wireless communication, additional controllers may connect to the wired controller 130 via the USB port 132. The battery 134 may supply power to the wired controller 130. For example, the battery 134 may be configured to supply power only when needed, such as when the wired controller 130 does not receive power from a wired source or when the wired controller 130 is in wireless mode. In embodiments, the wired controller 130 may receive power through a wired connection via the USB port 132 or other wired connection.

The wired controller 130 may be configured to determine whether it should communicate wirelessly or via a wired connection. For example, the wired controller 130 may operate in wireless mode when no other controllers are connected to it through a wired connection. Alternatively, when one or more controllers are connected to the wired controller 130 through a wired connection, such as through the USB port 132, the wired controller 130 may choose to operate in wired mode. In embodiments, a switch may control whether the wired controller 130 operates in a wired mode or wireless mode.

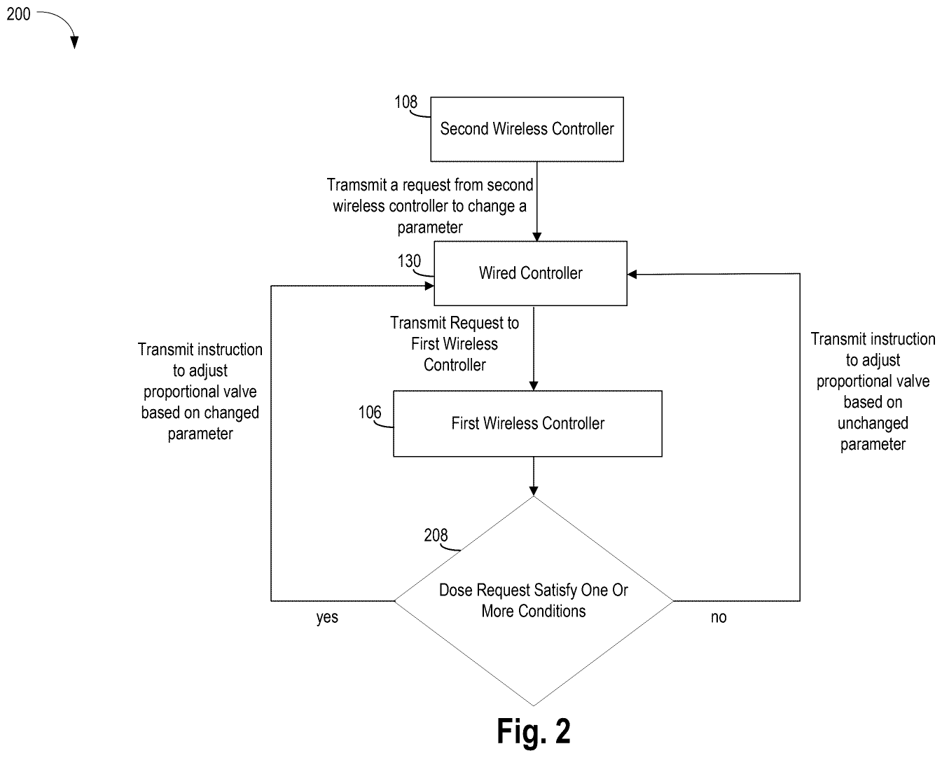

Referring to FIG. 2, FIG. 2 is a flow diagram of a process 200 for modifying one or more parameters in an embodiment of the disclosed system for mass flow control. The process 200 may allow an instruction from a wireless controller to transmit a request that will change one or more parameters for a mass flow control system. For example, a user may use a mobile device to transmit a signal to a mass flow control system to request a change in the mass flow control system. The mass flow control system will relay the request to a wireless controller to evaluate the request and make the requested change responsive to the evaluation.

A second wireless controller 108 may transmit wireless requests to a wired controller 130. The second wireless controller 108 may be any computational system with a processor coupled to a memory, sending a wireless signal to the wired controller 130. The wired controller 130 may be a computer system that is connected through a wired connection to one or more components of a mass flow system, including the main fluid flow path 102, one or more valves connected to the main fluid flow path 102, including the proportional valve 112 and shut-off valve 110, and the one or more sensors 114.

An example of the request may be a request to change a flow rate of a fluid flowing through the main fluid flow path 102. For instance, the request may include changing the setpoint flow rate of a fluid flowing through the main fluid flow path 102 from 200 grams per minute (g/min) to 500 g/min. Another example of a request may be to change the fluid composition controlled by the mass flow control system.

The wired controller 130 may transmit the request to the first wireless controller 106. The first wireless controller 106 may receive from the wired controller 130 and perform an evaluation 208 whether the request satisfies one or more conditions. If the request does satisfy one or more conditions, the first wireless controller 106 may change the parameter according to the request and determine adjustments to the proportional valve 112 based on the changed parameter. Accordingly, the first wireless controller 106 may transmit an instruction to adjust the proportional valve 112 based on the changed parameter in the request. If the evaluation 208 determines that the request does not satisfy the one or more conditions, the first wireless controller 106 will not change the parameter and will continue to transmit instructions to the proportional valve 112 based on the unchanged parameters.

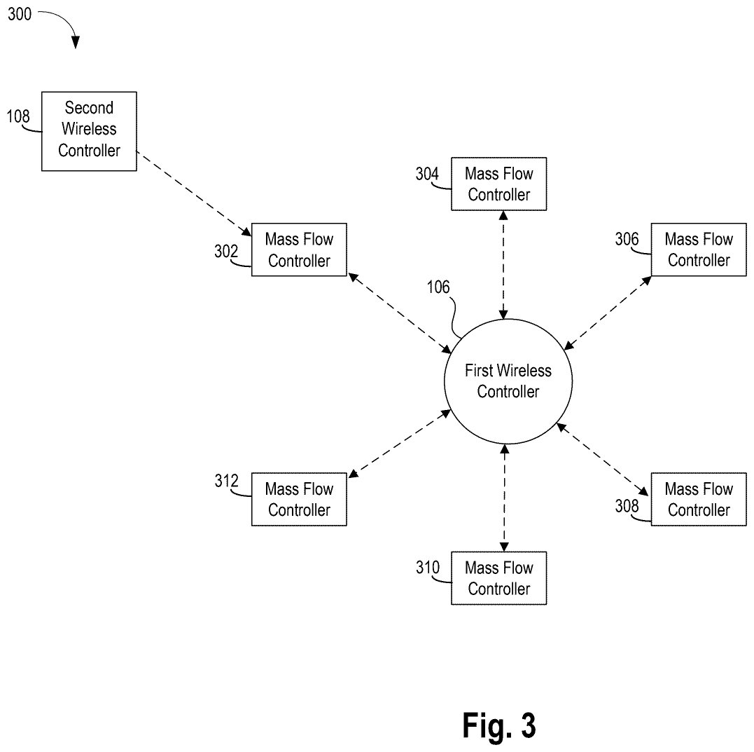

Referring to FIG. 3, FIG. 3 is a schematic diagram 300 of a system of communication between multiple mass flow controllers, a first wireless controller 106, and a second wireless controller 108 in an embodiment of the disclosed system for mass flow control. The first wireless controller 106 may manage multiple mass flow controllers in a system of mass flow controllers. For example, the first wireless controller 106 may concurrently send instructions to control a flow of fluid through the first mass flow controller 302, a second mass flow controller 304, a third mass flow controller 306, a fourth mass flow controller 308, a 5th mass flow controller 310, and a sixth mass flow controller 312.

The second wireless controller 108 may transmit a request to change a parameter on any of the mass flow controllers in the system. For example, a user may transmit the request to a mass flow controller to change when the user cannot access other mass flow controllers in the system. In the example shown in the schematic diagram 300, the second wireless controller 108 may transmit a request to the first mass flow controller 302, whereby the first mass flow controller 302 relays the request to the first wireless controller 106.

The first wireless controller 106 may perform the evaluation 208, considering the other mass flow controllers in the system. For example, the six mass flow controllers and the system may be configured to release a fluid flow into a combined flow path by combining six separate gases into the composition of the six gases. The first wireless controller 106 may be configured to evaluate the second wireless controller 108 request based on any adjustments that would have to be made to the other mass flow controllers. For example, a request to increase the flow rate in the first mass flow controller 302 may require an increase in the flow rates of the other mass flow controllers.

In another example of use, the second wireless controller 108 may request a change in the composition of fluid flowing through the first mass flow controller 302. For instance, the request may be to change the composition of a gas flowing through the first mass flow controller 302 from nitrogen to argon. The first wireless controller may modify a calculation to determine the adjustment for the proportional valve 112 based on the change in composition. Accordingly, a user with wireless access to one mass flow controller and a system of mass flow controllers may request one mass flow controller and change a parameter that may affect all mass flow controllers in the system. The request may be evaluated based on preset conditions by the first wireless controller 106.

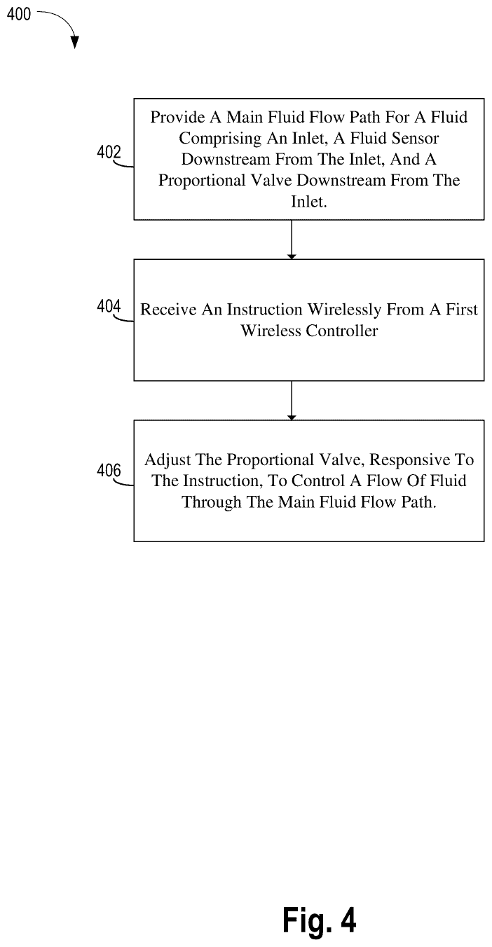

Referring to FIG. 4, FIG. 4 is a flow diagram 400 for an embodiment of the disclosed process for controlling fluid flow, with an embodiment of the disclosed system for mass flow control. The process may allow a mass flow controller to be operated by a wireless controller and wireless communication with the mass flow controller. The first wireless controller 106 may receive signals from the mass flow controller, such as from sensors, as well as the state of the various valves and the mass flow controller. The first wireless controller 106 may generate instructions to control fluid flow through the mass flow controller based on sensor measurements and the state of the various valves in the mass flow controller.

At step 402, the process may provide a main fluid flow path 102 for a fluid comprising an inlet 120, a fluid sensor downstream from the inlet 120, and a proportional valve 112 downstream from the inlet 120. The inlet 120, fluid sensor, and proportional valve 112 are coupled to the main fluid flow path 102. In an exemplary embodiment, the various components of the mass flow controller may be connected to a wired controller 130 that is in communication with one or more wireless controllers. The various components of the mass flow controller may be configured to directly transmit or receive signals from the wireless controller without going through a wired controller 130.

At step 404, the process may receive an instruction wirelessly from the first wireless controller 106. For example, the first wireless controller may transmit an instruction to adjust an opening in the proportional valve 112. At step 406, the process may adjust the proportional valve responsive to the instruction to control fluid flow through the main fluid flow path 102.

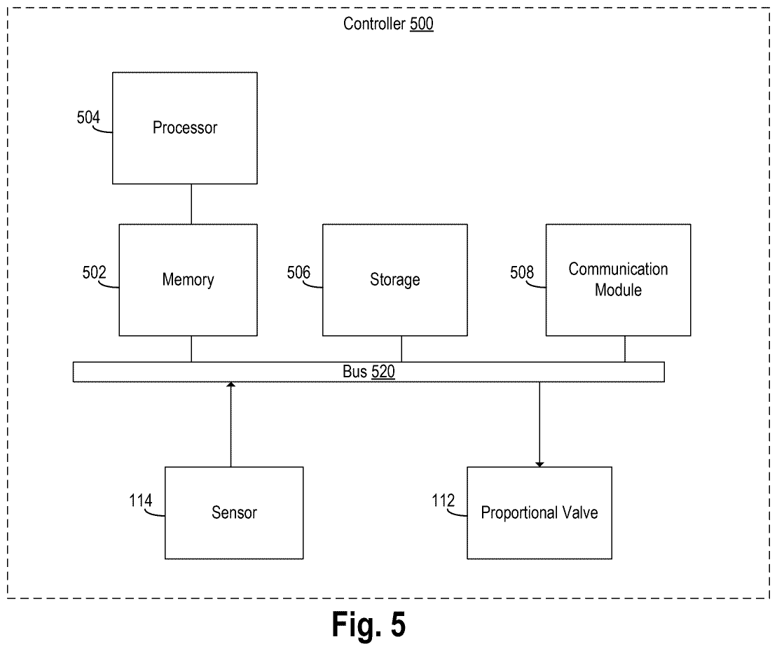

Referring to FIG. 5, FIG. 5 is a schematic of an embodiment of a computing system for a controller 500 that may perform one or more computing functions and embodiments of the disclosed system for mass flow control. The computing system may include a controller 500 and a processor 504 coupled to a memory 502. The processor 504 may process and generate instructions to and from the memory 502. Examples of the processor 504 include but are not limited to central processing units (CPU), general purpose processing units (GPU), complex programming logic devices (CPLD closed parentheses, field programming gate arrays (FPGA), and application-specific integrated circuits (ASIC).

The memory 502 may transmit instructions from the processor 504 to one or more components in the controller 500 via a bus 520. Examples of memory 502 include random access memory (RAM) and read-only memory (ROM). The storage 506 may store data or instructions to be accessed by the memory 502. Examples of storage 506 include solid-state drives and spinning disk drives. The communication module 508 may include an antenna for receiving and transmitting wireless transmissions.

The one or more sensors 114 may transmit measurements to the storage 506 and/or the memory 502 via the bus 520. Measurements 13 may be evaluated by the memory and processor to determine an adjustment to the proportional valve 112. The adjustment may be transmitted from the memory 502 to the proportional valve one or two, shut-off valve 110, or any other valve in the mass flow control system.

An exemplary embodiment is a method. The method includes providing a main fluid flow path for a fluid. The main fluid flow path includes an inlet, a fluid sensor downstream from the inlet, and a proportional valve downstream from the inlet. The method further includes receiving instructions wirelessly from my first wireless controller and adjusting the proportional valve, which is responsive to the instructions, to control fluid flow through the main fluid flow path. The method may further include receiving, by the first wireless controller, a set point flow rate for the fluid where the instruction comprises the set point flow rate. The method may further include receiving a measurement by the fluid sensor, wirelessly transmitting the measurement to the controller, and determining, by the first wireless controller, and instruction to adjust the proportional valve to control the flow of fluid through the main fluid flow path at the set point flow rate responsive to the measurement. The proportional valve and fluid sensor may include the solenoid valve. The method may further include receiving a parameter from a second wireless controller and transmitting the parameter to the first wireless controller where determining the instruction is responsive to the parameter. Receiving the parameter may be performed by a wired controller connected to the main fluid flow path. The method may further include receiving, by the first wireless controller, requests to change the set point flow rate. The method may further include changing the set point flow rate by the first wireless controller responsive to the request. The method may further include evaluating the request against one or more conditions by the first wireless controller and changing the setpoint flow rate responsive to the evaluation.

Another general aspect is a system for mass flow control. The system includes a main fluid flow path, an inlet for the main fluid flow path, a fluid sensor downstream on the main fluid flow path from the inlet, a proportional valve downstream on the main fluid flow path from the inlet, and a first controller configured to wirelessly transmit instructions to the proportional valve to adjust a flow of fluid flowing through the main fluid flow path. The first wireless controller may be further configured to receive a set point flow rate for the fluid whose instruction comprises the set point flow rate. The system may further include a transmitter connected to the main fluid flow path, where the transmitter is configured to receive a measurement from the fluid sensor and transmit the measurement to the wireless controller. The first wireless controller may be further configured to determine an instruction to adjust the proportional valve to control the fluid flow through the main fluid flow path at the set point flow rate responsive to the measurement. The proportional valve may include a solenoid valve, whereas the fluid sensor also includes the solenoid valve. The system may further include a receiver configured to receive a parameter from a second wireless controller and transmit the parameter to the first wireless controller. The first wireless controller may be further configured to determine the instruction responsive to the parameter. The receiver may include a wired controller connected to the main fluid flow path. The first wireless controller may be further configured to receive a request to change the setpoint flow rate and the setpoint flow rate responsive to the request. The first wireless controller may be further configured to evaluate the request against one or more conditions and change the set point flow rate responsive to the evaluation.

An exemplary embodiment is a device for mass flow control. The device includes a main fluid flow path, an inlet to the main fluid flow path, a fluid sensor downstream on the main fluid flow path from the inlet, and a proportional valve downstream on the main fluid flow path from the inlet where the proportional valve is configured to adjust a flow of fluid flowing through the main fluid flow path responsive to an instruction from a first wireless controller. The device may further include a receiver configured to receive a parameter from a second wireless controller and transmit the parameter to the first wireless controller, where the first wireless controller is configured to determine the instruction responsive to the parameter. The receiver may be further configured to receive a request to change the set point flow rate and transmit the request to the first wireless controller. The receiver may include a wired controller connected to the main fluid flow path. The wired controller may include an antenna that transmits data to and from the first and second wireless controllers. The antenna may be detachable from the wired controller. The wired controller may be configured to operate in one of a wired mode, or a wireless mode where the wired mode includes communication with one or more controllers via a wired connection and the wireless mode includes communication with one or more controllers via a wireless connection

Many variations may be made to the embodiments of the software project described herein. All variations, including combinations of variations, are intended to be included within the scope of this disclosure. The description of the embodiments herein can be practiced in many ways. Any terminology used herein should not be construed as restricting the features or aspects of the disclosed subject matter. The scope should instead be construed by the appended claims.

1. A method, the method comprising:
providing a main fluid flow path for a fluid comprising:
an inlet;
a fluid sensor downstream from the inlet; and
a proportional valve downstream from the inlet;
receiving an instruction wirelessly from a first wireless controller; and
adjusting the proportional valve, responsive to the instruction, to control a flow of fluid through the main fluid flow path.

2. The method of claim 1, further comprising receiving, by the first wireless controller, a setpoint flow rate for the fluid,
wherein the instruction comprises the setpoint flow rate.

3. The method of claim 2, further comprising:
receiving a measurement by the fluid sensor;
wirelessly transmitting the measurement to the first wireless controller; and
determining, by the first wireless controller, an instruction to adjust the proportional valve to control the flow of fluid through the main fluid flow path at the setpoint flow rate responsive to the measurement.

4. The method of claim 3, wherein the proportional valve comprises a solenoid valve; and
wherein the fluid sensor comprises the solenoid valve.

5. The method of claim 4, further comprising:
receiving a parameter from a second wireless controller; and
transmitting the parameter to the first wireless controller,
wherein determining the instruction is responsive to the parameter.

6. The method of claim 5, wherein receiving the parameter is performed by a wired controller that is connected to the main fluid flow path.

7. The method of claim 6, further comprising:
receiving, by the first wireless controller, a request to change the setpoint flow rate; and
changing the setpoint flow rate, by the first wireless controller responsive to the request.

8. The method of claim 7, further comprising:
evaluating, by the first wireless controller, the request against one or more conditions; and
changing the setpoint flow rate responsive to the evaluation.

9. A system for mass flow control, the system comprising:
a main fluid flow path;
an inlet to the main fluid flow path;
a fluid sensor downstream on the main fluid flow path from the inlet;
a proportional valve downstream on the main fluid flow path from the inlet; and
a first controller configured to wirelessly transmit instructions to the proportional valve to adjust a flow of a fluid flowing through the main fluid flow path.

10. The system of claim 9, wherein the first wireless controller is further configured to receive a setpoint flow rate for the fluid; and
wherein the instruction comprises the setpoint flow rate.

11. The system of claim 10, further comprising a transmitter connected to the main fluid flow path, the transmitter configured to:
receive a measurement from the fluid sensor; and
transmit the measurement to the first wireless controller,
wherein the first wireless controller is further configured to determine an instruction to adjust the proportional valve to control the flow of fluid through the main fluid flow path at the setpoint flow rate responsive to the measurement.

12. The system of claim 11, wherein the proportional valve comprises a solenoid valve; and
wherein the fluid sensor comprises the solenoid valve.

13. The system of claim 12, further comprising a receiver configured to:
receive a parameter from a second wireless controller; and
transmit the parameter to the first wireless controller,
wherein the first wireless controller is further configured to determine the instruction responsive to the parameter.

14. The system of claim 13, wherein the receiver comprises a wired controller that is connected to the main fluid flow path.

15. The system of claim 14, wherein the first wireless controller is further configured to:
receive a request to change the setpoint flow rate; and
change the setpoint flow rate responsive to the request.

16. The system of claim 15, wherein the first wireless controller is further configured to:
evaluate the request against one or more conditions; and
change the setpoint flow rate responsive to the evaluation.

17. A device for mass flow control, the device comprising:
a main fluid flow path;
an inlet to the main fluid flow path;
a fluid sensor downstream on the main fluid flow path from the inlet; and
a proportional valve downstream on the main fluid flow path from the inlet, the proportional valve configured to adjust a flow a fluid flowing through the main fluid flow path responsive to an instruction from a first wireless controller.

18. The device of claim 17, further comprising a receiver configured to:
receive a parameter from a second wireless controller; and
transmit the parameter to the first wireless controller,
wherein the first wireless controller is configured to determine the instruction responsive to the parameter.

19. The device of claim 18, wherein the receiver is further configured to:
receive a request to change a setpoint flow rate; and
transmit the request to the first wireless controller.

20. The device of claim 19, wherein the receiver comprises a wired controller that is connected to the main fluid flow path,
wherein the wired controller comprises an antenna that transmits data to and from the first wireless controller and the second wireless controller,
wherein the antenna is detachable from the wired controller, and
wherein the wired controller is configured to operate in one of a wired mode or a wireless mode, the wired mode comprising the wired controller configured to communicate with one or more controllers via a wired connection and the wireless mode comprising wired controller configured to communicate with one or more controllers via a wireless connection.
